(19) United States
(12) Patent Application Publication
(10) Pub. No.: US 2003/0155240 A1
(43) Pub. Date: Aug. 21, 2003

(54) Fuel cell gas sensors

(76) Inventor: Ilhan Ulkem, Dollard-des-Ormeaux (CA)

Correspondence Address: OGILVY RENAULT, 1981 MCGILL COLLEGE AVENUE, SUITE 1600, MONTREAL, QC, H3A2Y3, CA

(21) Appl. No.: 10/281,276

(22) Filed: Oct. 28, 2002

Related U.S. Application Data
(63) Continuation of application No. 09/887,257, filed on Jun. 25, 2001, now abandoned.

(30) Foreign Application Priority Data
Jun. 23, 2000 (CA) 2,312,259

(51) Int. Cl. G01N 27/26

(52) U.S. Cl. 204/429; 204/431

(57) ABSTRACT

A fuel cell gas sensor for detecting gases such as Hydrogen (H₂) and Carbon Monoxide (CO) comprises a main body (10) in which are mounted a protection membrane (11), a working electrode (12), electrolyte (13), a counter electrode (14), a protection membrane (15) and respective contacts (16). A catalyst disk (17a) or a very low impedance fuel cell (17b) in placed between the counter electrode (14) and the protection membrane (15). The membrane (15) slows down the flux of gases onto the counter electrode (14). The catalyst disk (17a) eliminates chemically while the fuel cell (17b) eliminates electrochemically the gases to be detected that permeate through the protection membrane (15). This arrangement makes it possible to detect the gases in places where the gases to be detected are able to reach both the working electrode (12) and the counter electrode (14).

### BACKGROUND OF THE INVENTION

1. Field of the Invention

The present invention relates to fuel cell gas sensors that are used for the detection of a variety of gases in particular, but not exclusively, oxidisable gases such as hydrogen and carbon monoxide gases.

2. Description of the Prior Art

Fuel cells were first invented by Sir William Grove in 1839 and in recent years have been used in many arrangements as gas sensors for the detection of oxidisable gases or vapours. Essentially, the fuel cell gas sensors each comprise a working electrode (or anode) and a counter electrode (or cathode) which are separated by an electrolyte, usually by a porous solid that is absorbent impregnated with an acidic electrolyte. The electrochemical oxidation of the fuel gases results in the development of an electrical potential difference which results in a flow of electrons from the anode to the cathode, and this current and/or potential difference can be detected. An example of such an arrangement is disclosed and described in the U.S. Pat. No. 5,738,773 which issued on Apr. 14, 1998 to Criddle et al.

Fuel cell gas sensors provide the following features: a) they have no consumable and wearing parts; b) they operate in passive mode; c) they do not need external excitation; d) they provide linear and fast response to gases in fairly large concentration range; and e) they are stable with time, provided that some necessary measures are taken.

A typical full cell sensor has two identical platinum/carbon electrodes. This make-up has the advantage of having small and stable offset potentials. However, since the gases to be detected are able to react electrochemically on both electrodes, it becomes a drawback it the sensor is used in places where the gases can reach both sides of electrodes. The effect on the sensor in such cases includes a drastic drop in the signal output, negative signal output or even zero signal output. This unpredictable behaviour renders the sensor useless.

One arrangement to address this problem is to polarise the working electrode by an external potential source. The reactions of gases are restricted on the working electrode. To achieve this, a third electrode, often called reference electrode, is necessary. An example of such arrangement is disclosed and described in U.S. Pat. No. 5,338,429 which issued on Aug. 16, 1994 to Jolson et al. Such sensors having a three-electrode arrangement are usually called electrochemical gas sensors.

However, the design of such three-electrode sensors is cumbersome, and the performance of the sensors depends often on the stability of the external potential source, which requires again a complex circuit.

It would thus be desirable to have a fuel cell gas sensor which did not have this drawback.

### SUMMARY OF THE INVENTION

It is therefore an aim of the present invention to provide an arrangement for fuel cell sensors that is not only able to detect oxidisable gases in places where the gases to be detected are restricted to the working electrode, but also able to detect the oxidisable gases in such places where the gases can reach both the working electrode and the counter electrode, in particular, but not exclusively, in ambient air space.

One aspect of this arrangement is to place a catalyst disk that is active to gases, such as hydrogen and carbon monoxide, at ambient temperatures in front of the counter electrode. The gases that permeate through the protection membrane will be eliminated, or reduced in concentration, by the catalyst before reaching the counter electrode. In the mean time, the oxygen in the ambient air is not obstructed and sufficient oxygen is still able to reach the counter electrode which is necessary for the fuel cell sensor to operate.

Another aspect of this arrangement is to place a very low impedance fuel cell active to gases, such as hydrogen and carbon monoxide, at ambient temperatures in front of the counter electrode. These gases that permeate through the protection membrane will either completely or partially be burned off by the fuel cell before reaching the counter electrode. In the meantime, the oxygen in the ambient air is not obstructed and sufficient oxygen is still able to reach the counter electrode which is necessary for fuel cell sensor to operate.

Traditionally, porous membranes have been used for the protection of sensors but they can cause the electrolyte to dry out or wet out very quickly, thereby reducing the life of the sensors.

The present invention also consists in protection membranes that have a good gases/water permeability ratio (H₂/H₂O ratio which is typically higher than 0.3) on the working electrode side, and a good oxygen/water permeability ratio (typically higher than 0.03) on the counter electrode side. The membranes are made with dense polymers. However, the oxygen ion/electronic mixed-conducting ceramic dense membranes, in particular but not exclusively, made with perovskite phase of composition La₁₋ₓAₓFe_{1-y}Co_{y}O₃ (A=Ba, Ca, Sr) as described by C. Y. Tsai et al (Fourth International Conference on Inorganic Membranes, Jul. 14-18, 1996, Gatlinburg, Tenn., USA), are also covered by the present invention although they may not always be practical to use in the sensor due to their high activation temperature which is usually higher than 700° C.

Therefore, in accordance with the present invention, there is provided a fuel cell sensor for detecting oxidisable gases, comprising working and counter electrodes, and a catalyst disk adapted to chemically oxidise gases on a counter electrode side of said counter electrode opposite a working electrode side thereof for reducing an amount gases that will reach said counter electrode from said counter electrode side.

Also in accordance with the present invention, there is provided a fuel cell sensor for detecting oxidisable gases, comprising working and counter electrodes, and a low impedance fuel cell adapted to electro-chemically oxidise gases on a counter electrode side of said counter electrode opposite a working electrode side thereof for reducing an amount gases that will reach said counter electrode from said counter electrode side.

Further in accordance with the present invention, there is provided a fuel cell sensor for detecting oxidisable gases, comprising working and counter electrodes, a protection membrane in front of said working electrode and made of dense polymer membrane of PTFE, or PFA or PVDF with a thickness between 5 to 50 microns, and a protection membrane in front of said counter electrode and made of oxygen ion/electronic mixed-conducting ceramic dense membranes, i.e. perovskite phase of composition La₁₋ₓAₓFe_{1-y}Co_{y}O₃ (A=Ba, Ca, Sr).

Still further in accordance with the present invention, there is provided a fuel cell gas sensor for detecting gases, comprises a housing in which are mounted a working electrode, an electrolyte, a counter electrode, first and second protection membranes located upstream respectively of said working and counter electrodes, respective contacts for said working and counter electrodes, and a gas reducer adapted to change a concentration of the gases to be detected by said gas sensor passing through said second protection membrane before reaching said counter electrode.

More particularly, said gas reducer comprises a catalyst disk placed between said counter electrode and said second protection membrane, said second protection membrane being adapted to slow down the flux of gases onto said counter electrode, said catalyst disk being adapted to chemically modify a concentration of the gases to be detected that permeate through said second protection membrane.

Alternatively, said gas reducer comprises a low impedance fuel cell placed between said counter electrode and said second protection membrane, said second protection membrane being adapted to slow down the flux of gases onto said counter electrode, said fuel cell being adapted to electrochemically modify a concentration of the gases to be detected that permeate through said second protection membrane.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1a is a schematic vertical cross-sectional view of a fuel cell gas sensor in accordance with a first embodiment of the present invention;

FIG. 1b is a schematic vertical cross-sectional view of a fuel cell gas sensor in accordance with a second embodiment of the present invention;

FIG. 2 is a schematic view of either one of the fuel cell gas sensors of FIGS. 1a and 1b, shown in use to detect oxidisable gases in places where the gases to be detected are restricted to a working electrode of the fuel cell gas sensor; and

FIG. 3 is a schematic view of either one of the fuel cell gas sensors of FIGS. 1a and 1b, shown in use to detect oxidisable gases in places where the gases can reach both a working electrode and a counter electrode of the fuel cell gas sensor.

### DETAILED DESCRIPTION OF THE INVENTION

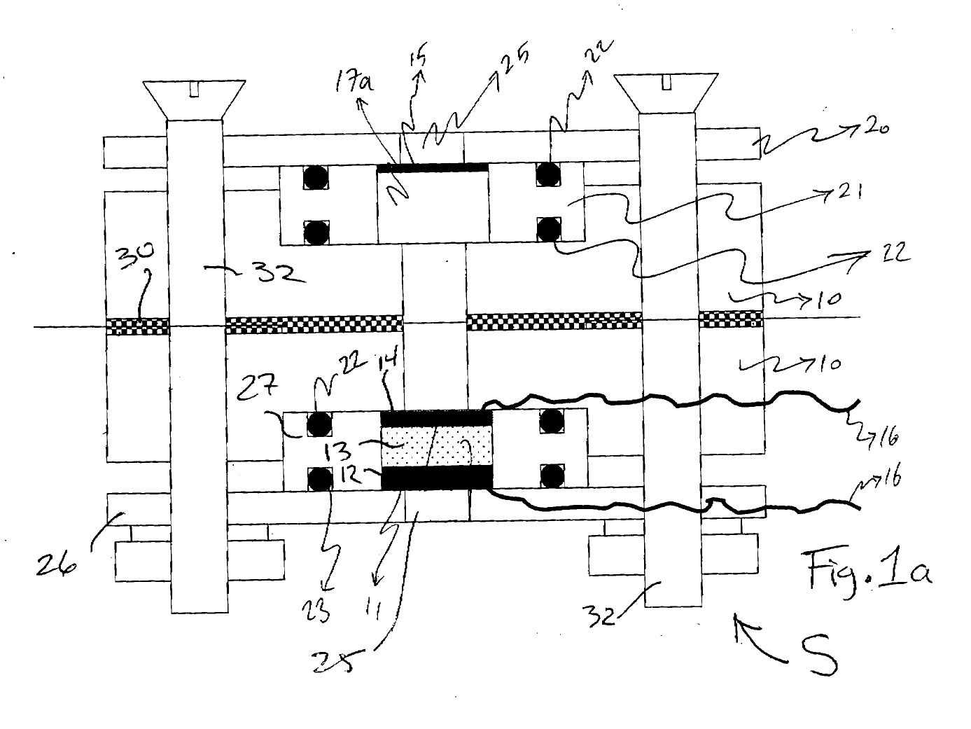

A pair of preferred embodiments of two fuel cell gas sensors S and S′ of the present invention are shown in FIG. 1a and FIG. 1b, respectively. Each of the sensors S and S′ has a two-part housing 10 and two pairs of opposite covers 20 and 21, and 26 and 27, which are preferably made of plastic materials, such as polyethylene or polypropylene, with a small hole 25 being defined in the middle of each of the covers 20, 21, 26 and 27 and through the housing 10. The small holes 25 have a diameter ranging between 2 to 8 mm, and preferably from 4 to 5 mm. A rubber annular gasket 30 is provided between the two sections of the housing 10 which are held together by screws or bolts 32 that extend through the housing 10 and the covers 20 and 26.

The small hole 25 allows the gases to be detected to permeate through a protection membrane 11 and reach a working electrode 12. The working electrode 12 and a counter electrode 14 are fuel cell grade electrodes preferably made of Pt black deposited on carbon cloth and are gas diffusive. The ionic conduction between the two electrodes 12 and 14 is ensured by an electrolyte gel 13 which is made by mixing a liquid electrolyte, preferably acidic electrolyte such as H₂SO₄, H₃PO₄ and a porous solid support such as silica and glass frit. Metal wires, preferably Pt and gold wires, are used as electric contacts 16 between the electrodes 12 and 14. The protection membrane 11, the electrodes 12 and 14 and the electrolyte gel 13 are mounted to the housing 10 with the covers 26 and 27. The gas tightness between the inside and outside electrodes 12 and 14 is ensured by O-rings 22 and 23.

The main body is closed off by the top and bottom covers 20, 21, 26 and 27, which also provide the sensor S/S′ with a mean to keep a good electric contact and good gas tightness.

The protection membrane 11 protects the sensor S/S′ from foreign contaminants such as particles and liquids, while allowing the gases to be detected to permeate therethrough very quickly. On the other hand, in order to extend the sensor life, it is preferable to use thin dense polymer membranes that have high gases/water permeability ratios, such as polytetrafluoroethylene (PTFE), polyvinyldenefluoride (PVDF) and polypropylene (PP) . Typically, the H₂/water permeability ratio of these protection membranes is higher than 0.30. The thickness of the membrane 11 is between 5 and 50 microns (0.005 to 0.05 mm), and preferably between 10 and 25 microns.

A membrane 15 protects the sensor S/S′ from foreign contaminants such as particles and liquids, while allowing the gases to be detected to permeate therethrough very quickly. On the other hand, in order to extend the sensor life and allow sufficient oxygen to permeate through the membrane 15, it is preferable to use thick dense polymer membranes that have high oxygen/water permeability ratio such as polytetrafluoroethylene (PTFE), polyethylene (PE) and polypropylene (PP). Typically, the oxygen/water permeability ratio is higher than 0.03. The thickness of the membrane 15 is between 20 and 100 microns (0.02 to 0.10 mm), and preferably between 25 and 50 microns.

An alternative to the membrane 15 is to use oxygen/ion electronic mixed-conducting ceramic dense membranes, in particular but not exclusively, made with perovskite phase of composition La₁₋ₓAₓFe_{1-y}Co_{y}O₃ (A=Ba, Ca, Sr). This kind of membrane has a characteristic of 100% selectivity to oxygen at high permeability at temperatures between 700 and 800° C. On the other hand, these are generally not practical to use in the sensor due to their high temperature requirement.

As it can be seen from FIG. 1a, the sensor S comprises a catalyst disk 17a that is placed between the counter electrode 14 and the protection membrane 15. The catalyst disk 17a and the membrane 15 are mounted to the housing 10 with the covers 20 and 21. The catalyst disk 17a chemically eliminates or reduces the concentration of the gases to be detected that enter from the protection membrane 15. The catalyst disk 17a can be made from the powder of two groups of catalysts. The first group consists of precious metal catalysts on a high surface support such as 0.5%-10% Pd and/or Pt load on activated carbon or Alumina. They have high activity at room temperature and oxidise the gases that permeate through the membrane 15. The second group consists of transition metal oxide catalysts including but not exclusively Moleculite from Molecular Products Ltd., a highly active Copper oxide (CuO)/Manganese Dioxide (MnO₂) mixture formulated for the low temperature oxidation of gases and contaminants.

An alternative arrangement is shown in FIG. 1b, where the catalyst disk 17a located between the counter electrode 14 and the protection membrane 15 in the sensor S of FIG. 1a is replaced by another fuel cell 17b that is similar to what is described above, The internal and external impedance of the close circuit should be small enough, preferably lower than 100 ohms, to burn off, at least partly, the said entering gases very quickly. Low impedance allows for a fast electrochemical reaction to take place in the fuel cell of the sensor S′.

The design of the catalyst disk 17a or fuel cell 17b is in such a way that the oxygen that permeates through the protection membrane 15 can reach the counter electrode 14. This is achieved by making small communication channels or holes on the catalyst disk 17a or on the fuel cell 17b. The preferable diameter of these channels or holes is smaller than 1 mm. In the case of the catalyst disk 17a of the sensor S of FIG. 1a, these small channels or holes can be assured by the inter-particle spaces of the powders.

As it has been explained above, in each of the configurations shown in FIG. 1a and in FIG. 1b, on one hand, the membrane 15 slows down the gases permeating through the membrane 15, and on the other hand, the catalyst disk 17a and the fuel cell 17b remove, or modify the concentration of, the gases that permeate through the membrane 15. This results in a more precise and more detectable differential potential between the working electrode 12 and counter electrode 14.

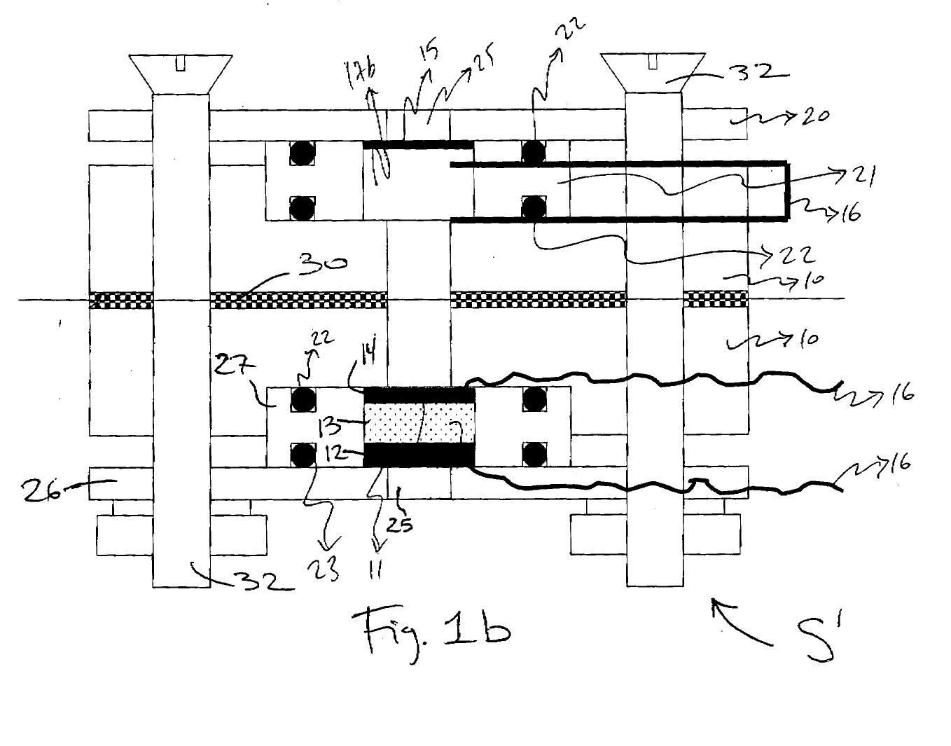

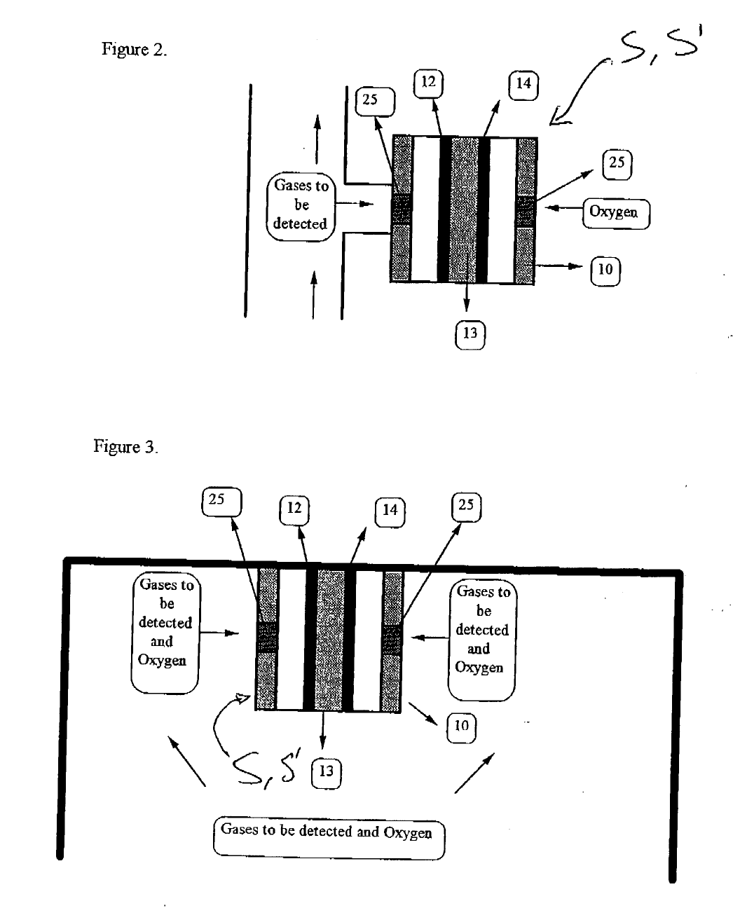

These characteristics not only mean that a fuel cell gas sensor can be used to detect the said gases in some restricted spaces such as fuel cell power generators, hydrogen and fuel cell powered automobiles (as for example shown in FIG. 2), but also means that it can be used to detect the said gases in places where the gases to be detected are able to reach both electrodes 12 and 14 (as for example shown in FIG. 3).

What is claimed is:

1. A fuel cell sensor for detecting oxidisable gases, comprising working and counter electrodes, and a catalyst disk adapted to chemically oxidise gases on a counter electrode side of said counter electrode opposite a working electrode side thereof for reducing an amount gases that will reach said counter electrode from said counter electrode side.

2. A fuel cell sensor as defined in claim 1, wherein said catalyst disk is made from the powders of 0.5-10% Pd and/or Pt load on activated carbon or alumina.

3. A fuel cell sensor as defined in claim 1, wherein said catalyst disk is made from the powders of transition metal oxides.

4. A fuel sensor as defined in claim 1, wherein a protection membrane in front of said working electrode is made of dense polymer membrane of PTFE, or PVDF or PP with a thickness between 5 and 50 microns.

5. A fuel cell sensor as defined in claim 1, wherein a protection membrane in front of said counter electrode is made of dense polymer membrane of PTFE, or PE or PP with a thickness between 20 and 100 microns.

6. A fuel cell sensor for detecting oxidisable gases, comprising working and counter electrodes, and a low impedance fuel cell adapted to electro-chemically oxidise gases on a counter electrode side of said counter electrode opposite a working electrode side thereof for reducing an amount gases that will reach said counter electrode from said counter electrode side.

7. A fuel cell sensor as defined in claim 6, wherein said low impedance fuel cell has combined internal and external impedance lower than 100 ohms.

8. A fuel sensor as defined in claim 6, wherein a protection membrane in front of said working electrode is made of dense polymer membrane of PTFE, or PVDF or PP with a thickness between 5 and 50 microns.

9. A fuel cell sensor as defined in claim 6, wherein a protection membrane in front of said counter electrode is made of dense polymer membrane of PTFE, or PE or PP with a thickness between 20 and 100 microns.

10. A fuel cell sensor for detecting oxidisable gases, comprising working and counter electrodes, a protection membrane in front of said working electrode and made of dense polymer membrane of PTFE, or PFA or PVDF with a thickness between 5 to 50 microns, and a protection membrane in front of said counter electrode and made of oxygen ion/electronic mixed-conducting ceramic dense membranes, i.e. perovskite phase of composition La₁₋ₓAₓFe_{1-y}Co_{y}O₃ (A=Ba, Ca, Sr).

11. A fuel cell gas sensor for detecting gases, comprises a housing in which are mounted a working electrode, an electrolyte, a counter electrode, first and second protection membranes located upstream respectively of said working and counter electrodes, respective contacts for said working and counter electrodes, and a gas reducer adapted to change a concentration of the gases to be detected by said gas sensor passing through said second protection membrane before reaching said counter electrode.

12. A fuel cell gas sensor as defined in claim 11, wherein said gas reducer comprises a catalyst disk placed between said counter electrode and said second protection membrane, said second protection membrane being adapted to slow down the flux of gases onto said counter electrode, said catalyst disk being adapted to chemically modify a concentration of the gases to be detected that permeate through said second protection membrane.

13. A fuel cell gas sensor as defined in claim 11, wherein said gas reducer comprises a low impedance fuel cell placed between said counter electrode and said second protection membrane, said second protection membrane being adapted to slow down the flux of gases onto said counter electrode, said fuel cell being adapted to electrochemically modify a concentration of the gases to be detected that permeate through said second protection membrane.

14. A fuel cell sensor as defined in claim 3, wherein said powders of transition metal oxides include a highly active CuO/MnO₂ mixture known as Moleculite.
